(19) United States
(12) Patent Application Publication
(10) Pub. No.: US 2024/0380035 A1
(43) Pub. Date: Nov. 14, 2024

(54) BATTERY PACKAGING MATERIAL

(71) Applicant: PANASONIC INTELLECTUAL PROPERTY MANAGEMENT CO., LTD., Osaka (JP)

(72) Inventor: Takatoshi ABE, Osaka (JP)

(73) Assignee: PANASONIC INTELLECTUAL PROPERTY MANAGEMENT CO., LTD., Osaka (JP)

(21) Appl. No.: 18/781,549

(22) Filed: Jul. 23, 2024

Related U.S. Application Data
(63) Continuation of application No. PCT/JP2023/001837, filed on Jan. 23, 2023.
(60) Provisional application No. 63/302,886, filed on Jan. 25, 2022.

(51) Int. Cl. H01M 50/124; H01M 50/105; H01M 50/119; H01M 50/121; H01M 50/129; H01M 50/133; H01M 50/136

(52) U.S. Cl. CPC H01M 50/124; H01M 50/105; H01M 50/119; H01M 50/121; H01M 50/129; H01M 50/133; H01M 50/136

(57) ABSTRACT

An aspect of the present invention relates to a battery packaging material including: a metal layer, and a substrate layer laminated on at least one surface of the metal layer, in which the substrate layer is formed of a thermosetting resin composition of which the cured product has a tensile modulus of 10 kPa or more and 100 MPa or less at 25° C.

### FIELD OF INVENTION

The present disclosure relates to a battery packaging material.

The main bodies of batteries used as power sources for mobile electrical machinery and apparatus such as cell phones, laptop computers, and digital cameras are usually wrapped in packaging materials composed of metal layers such as aluminum foil, substrate films and the like.

In recent years, as mobile electrical machinery and apparatus have become smaller and lighter, it has also been attempted to save the weight of lithium ion secondary batteries and lithium polymer batteries installed in these by using thin laminate exterior materials as packaging materials of the batteries.

For example, Patent Literature 1 discloses an exterior material for power storage devices in which aluminum foil, an adhesive layer formed of electron beam curable resin and the like, and a substrate layer mainly formed of a thermoplastic resin are laminated. Patent Literature 2 discloses a laminate exterior material for batteries that includes a metal foil, a base film formed of a thermoplastic resin, and a coating layer formed of a thermoadhesive resin.

The conventional battery packaging materials disclosed in these literatures and the like are aimed at securing barrier properties, toughness, and insulation properties, and thus are laminates composed of materials having a relatively high elastic modulus.

Meanwhile, in recent years, batteries have been expected to be applied to devices that are required to exhibit flexibility and stretchability, such as wearable devices and soft robots, and there is a need for the development of flexible batteries. However, in the case of conventional battery packaging materials as described above, there are restrictions on the thickness and it is difficult to obtain flexibility.

In particular, flexible batteries are expected to be exposed to deformation loads associated with operations such as frequent bending, and there is thus a need for packaging materials that can safely and reliably seal batteries. The solution is expected to be achieved by improving the flexibility of film materials used as a substrate for such packaging materials, but currently, only thermoplastic resins such as polyester are used.

An object of the present disclosure is to provide a packaging material that exhibits flexibility and resistance to deformation loads and can safely and reliably seal a battery.
Patent Literature 1: JP 2022-70961 A
Patent Literature 2: JP 2007-173049 A

### SUMMARY OF THE INVENTION

The present inventors found out that the problems can be solved by the following configuration as a result of intensive studies, and completed the present invention by further conducting studies based on this finding. In other words, a battery packaging material according to an aspect of the present disclosure includes: a metal layer; and a substrate layer laminated on at least one surface of the metal layer, in which the substrate layer is formed of a thermosetting resin composition of which a cured product has a tensile modulus of 10 kPa or more and 100 MPa or less at 25° C.

### BRIEF DESCRIPTION OF THE DRAWINGS

FIG. 1 is a schematic cross-sectional view illustrating a battery packaging material according to an embodiment of the present disclosure.

FIG. 2 is a schematic cross-sectional view illustrating a battery packaging material according to another embodiment of the present disclosure.

FIG. 3 is a schematic cross-sectional view illustrating a battery packaging material according to still another embodiment of the present disclosure.

FIG. 4 is a schematic cross-sectional view illustrating a battery packaging material according to yet still another embodiment of the present disclosure.

### DETAILED DESCRIPTION

The battery packaging material of the present embodiment includes: a metal layer; and a substrate layer laminated on at least one surface of the metal layer. The substrate layer is formed of a thermosetting resin composition, and the cured product of the thermosetting resin composition has a tensile modulus of 10 kPa or more and 100 MPa or less at 25° C.

By such a configuration, it is possible to obtain a battery packaging material that is equipped with flexibility and is excellent in resistance to deformation loads. Such a battery packaging material of the present embodiment can be used as a packaging material for various batteries, and is also suitable as a packaging material for flexible batteries, for example.

Hereinafter, several embodiments according to the present invention will be described in more detail with reference to specific examples, drawings, and the like, but the present invention is not limited thereto.

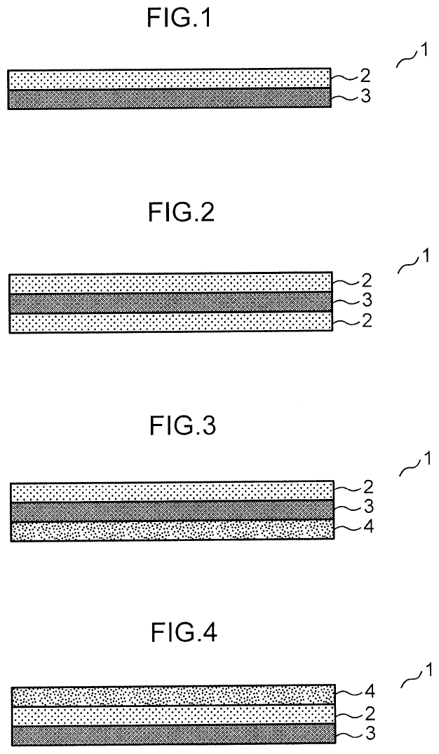

As illustrated in FIG. 1, a battery packaging material (hereinafter also simply referred to as “packaging material”) 1 of the present embodiment includes a metal layer 3 and a substrate layer 2 laminated on at least one surface of the metal layer 3. This substrate layer 2 may be provided on both surfaces of the metal layer 3 as illustrated in FIG. 2.

The packaging material 1 of the present embodiment includes the substrate layer 2 formed of a thermosetting resin composition, and does not require an adhesive agent layer or the like unlike conventional packaging materials. This is because the thermosetting resin composition exhibits adhesive properties in an uncured or semi-cured state, and can be thus bonded to battery cells before being cured.

The packaging material 1 according to the present embodiment may include a cured or semi-cured product of the thermosetting resin composition as the substrate layer 2, or may include the uncured resin composition itself as the substrate layer 2.

In the present embodiment, the “cured product” of the thermosetting resin composition refers to the state of a resin in which the curing reaction of the resin has been completed through a process of applying sufficient energy, such as heat or light, for curing to the resin composition. The “semi-cured product” is one in a state in which the resin composition is partially cured so as to be further cured. In other words, the semi-cured product is the resin composition in a semi-cured state (B-staged). For example, when a resin composition is heated, the viscosity of the resin composition first gradually decreases, then curing starts, and the viscosity gradually increases. In such a case, the semi-cured state includes a state in which the viscosity has started to increase but curing is not completed, and the like.

The packaging material 1 of the present embodiment may further include an adhesive layer 4. As described above, in the packaging material 1 of the present embodiment, the substrate layer 2 can exhibit adhesive properties, so the adhesive layer is not essential. However, in order to impart adhesive properties to the substrate layer 2, the thermosetting resin composition constituting the substrate layer 2 is required to be maintained in an uncured or semi-cured state. Hence, when the productivity in the case of continuous production is taken into account, it is considered that it is advantageous to provide the adhesive layer 4.

The adhesive layer 4 may be provided on the surface of the metal layer 3 opposite to the surface in contact with the substrate layer 2 as illustrated in FIG. 3, or may be provided on the surface of the substrate layer 2 opposite to the surface in contact with the metal layer 3 as illustrated in FIG. 4.

Next, each configuration of the packaging material according to the present embodiment will be described.

### (Metal Layer)

The metal layer in the present embodiment is used as a barrier layer of the packaging material. Such a metal layer is not particularly limited as long as it is a thin metal film, and a metal foil may be used, or a thin metal film formed by vapor deposition, plating, printing or the like may be used.

For example, as the metal foil, copper foil, aluminum foil, titanium foil, stainless steel foil, aluminum alloy foil, beryllium copper foil, phosphor bronze foil, nickel foil, nichrome foil, nickel alloy foil, tin foil, zinc foil, tantalum foil, molybdenum foil, niobium foil, iron foil, silver foil, gold foil, platinum foil, and a metal foil formed of an alloy of these metals can be used. Among these, it is preferable to use aluminum foil, copper foil and the like from the viewpoint of availability, economic efficiency, and barrier performance. In the case of using aluminum foil, the aluminum foil may be subjected to heat treatment (annealing). This affords the advantage that the metal layer becomes more pliable and is likely to follow the battery cells when used as a packaging material.

Examples of metal foil films other than these include vapor deposited films containing the same metals as the above-mentioned metal foils or alloys thereof as elements. As the deposition method, vacuum deposition, chemical reaction deposition such as CVD, and the like can be used without particular limitation. The metal foil film may be a metal film formed by plating methods such as electroless plating and electrolytic plating; or printing through ink application using a screen, stencil, or inkjet. There are no particular limitations on the ink or paste used for printing as long as it contains a material used as a barrier layer, but for example, sinterable ink, ink containing nanoparticles, ink containing metal particles, and reducible metal complexes can be used.

The thickness of the metal layer in the present embodiment is not particularly limited, but is preferably 0.1 μm or more in order to use the metal layer as a barrier layer, and is preferably 100 μm or less in order not to impair flexibility. In order to achieve both barrier properties and flexibility, the thickness is more preferably 1 μm or more and 50 μm or less, still more preferably 5 μm or more and 20 μm or less.

From the viewpoint of adhesive properties and reliability, the metal layer in the present embodiment preferably has a surface roughness (Rz) of 0.5 μm or more and 5 μm or less. A more preferable range of the surface roughness is 1.0 μm or more and 3.5 μm or less.

### (Substrate Layer)

The substrate layer of the packaging material of the present embodiment is formed of a thermosetting resin composition. The cured product of the thermosetting resin composition has a tensile modulus of 10 kPa or more and 100 MPa or less at 25° C. As the substrate layer is formed of such a thermosetting resin composition, it is possible to obtain a battery packaging material equipped with flexibility. The packaging material of the present embodiment is also excellent in resistance to deformation loads, thus can be used as a packaging material for various batteries, and is also suitable as a packaging material for flexible batteries, for example.

A more preferable range of the tensile modulus is 50 kPa or more and 20 MPa or less.

In the present embodiment, the tensile modulus is a value measured by the following method.

First, the cured product of the resin composition constituting the substrate layer is cut to a thickness of 50 μm and a sample shape: a size 6 dumbbell (measured part width: 4 mm, parallel part length: 25 mm), a tensile test is performed at a speed of 25 mm/min using a tensile tester (Autograph (model: AGS-X) manufactured by Shimadzu Corporation) conforming to ISO3384, the slope is calculated from the stress displacement amount and strain amount at two points of 1% strain and 5% strain, and the elastic modulus is calculated.

Examples of the thermosetting resin used to prepare a thermosetting resin composition having such a tensile modulus include resins that utilize the curing reaction between hydroxyl groups and isocyanates, such as epoxy resins, acrylic resins, and curable urethane resins; and resins that utilize the radical reaction of unsaturated bonds such as vinyl groups. Among these, it is preferable to use epoxy resins from the viewpoint of excellent heat resistance.

In addition to the resins, a polyrotaxane resin may also be contained. A polyrotaxane resin is a resin having a structure in which a linear axial molecule passes through a cyclic molecule and the ends are blocked to prevent the cyclic molecule from coming off. Specifically, polyrotaxanes such as those described in Japanese Patent No. 4482633 may be mentioned. In the thermosetting resin composition of the present embodiment, it is preferable that a functional group for reacting with this polyrotaxane resin is introduced, and examples of such a functional group include a hydroxyl group, a carboxyl group, a (meth)acrylic group, an epoxy group, and a vinyl group.

Epoxy resins are not particularly limited, but examples thereof include bisphenol A type epoxy resin, bisphenol F type epoxy resin, or high molecular weight epoxy resins of these; epoxy resins modified with alkyl groups such as an ethyl group, a propyl group, and a butyl group, acrylic modified epoxy resin, epoxy modified acrylic resin obtained by polymerization of glycidyl acrylate, cresol novolac type epoxy resin, phenol novolac type epoxy resin, epoxy modified styrene butadiene resin, and low elastic epoxy resin having one or more of these structures introduced into the skeleton.

The epoxy resin used in the present embodiment preferably has an epoxy equivalent weight of 400 g/eq or more. This affords the additional advantage that it is possible to achieve both mechanical and chemical properties such as toughness, flexibility, and heat resistance. As epoxy resins having an epoxy equivalent weight of 400 g/eq or more, commercially available ones may be used, and examples thereof include JER (registered trademark) 1003 (manufactured by Mitsubishi Chemical Corporation, epoxy equivalent weight 650 g/eq), EXA-4816 (manufactured by DIC Corporation, epoxy equivalent weight 500 g/eq), ST-6100 (manufactured by NIPPON STEEL Chemical & Material Co., Ltd., epoxy equivalent weight 1000 g/eq), EP-4003S (manufactured by ADEKA Corporation, epoxy equivalent weight 500 g/eq), and YL-7175-1000 (manufactured by Mitsubishi Chemical Corporation, epoxy equivalent weight 500 g/eq).

Thermosetting resins as mentioned above can be used singly or in combination of two or more thereof.

In the thermosetting resin composition of the present embodiment, the mixed amount of the thermosetting resin as mentioned above is not particularly limited as long as it plays a role as a main agent, but is usually preferably about 30 mass % or more and 98 mass % or less with respect to the entire amount of the resin composition. A more preferable mixed amount is 50 mass % or more and 90 mass % or less.

The thermosetting resin composition used in the present embodiment may further contain a curing agent for the purpose of curing the thermosetting resin. Examples of the curing agent include phenolic curing agents, amine-based curing agents, acid anhydride-based curing agents, ester-based curing agents, imidazole-based curing agents, dicyandiamide, cationic curing agents, and metal soaps. These can be used without particular limitation, and may be used singly or in combination of a plurality thereof.

In the present embodiment, the mixed amount of the curing agent is not particularly limited as long as it plays a role as a curing agent, but is preferably about 0.01 mass % or more and 30 mass % or less with respect to the entire amount of the resin composition. A more preferable mixed amount is 5 mass % or more and 20 mass % or less.

The resin composition of the present embodiment may contain additives, various elastomers, fillers and the like as components other than those mentioned above.

Examples of additives include dispersants, surfactants, colorants, and fillers. Examples of various elastomers include elastomers such as core-shell elastomer, acrylic, urethane, ethylene propylene diene rubber (EPDM), silicone, and fluorine-based rubber. These may be used singly or in combination of a plurality thereof.

The mixed amount of these other components can be appropriately set depending on their roles, and is not particularly limited, but is preferably about 0.001 mass % or more and 50 mass % or less with respect to the entire amount of the resin composition.

The thickness of the substrate layer in the present embodiment is not particularly limited as long as it plays a role as a substrate layer of the packaging material, but is preferably about 1 μm or more and 300 μm or less from the viewpoint of having both properties of flexibility and strength as a support for the packaging material. The thickness is more preferably 5 μm or more and 150 μm or less, still more preferably 6 μm or more and 50 μm or less.

### (Adhesive Layer)

The packaging material of the present embodiment may include an adhesive layer as described above. The adhesive layer in the present embodiment is not particularly limited as long as it is formed of a material exhibiting adhesive properties.

The adhesive layer in the present embodiment may be formed of, for example, at least one selected from thermoplastic resins that are composed of acid modified polyolefins, styrene elastomers, ethers, vinyl acetate and the like and can be bonded by thermocompression in addition to acrylic resins, urethane resins, ethylene propylene diene rubber (EPDM), silicone, fluorine-based resins. In addition to these thermoplastic resins, the thermosetting resins can also be semi-cured and used as the adhesive layer. These resins in a semi-cured state refer to ones that can be molded at room temperature or by hot pressing, and then are fully cured in the subsequent curing process. The curing process can be performed using heat or light such as ultraviolet light.

The thickness of the adhesive layer in the present embodiment is not particularly limited as long as sealing can be achieved by bonding, but is preferably 0.1 μm or more and 200 μm or less, still more preferably 0.5 μm or more and 50 μm or less from the viewpoint of achieving both properties of bonding strength and flexibility.

The packaging material of the present embodiment is preferably equipped with heat resistance. More specifically, the thermal decomposition temperature of the packaging material of the present embodiment is preferably 200° C. or more. The thermal decomposition temperature is more preferably 250° C. or more. The upper limit of the thermal decomposition temperature is not particularly limited, but is usually 300° C. or less from the viewpoint of cost and the like.

### (Method for Fabricating Packaging Material)

The method for fabricating the packaging material of the present embodiment is not particularly limited, but as an example, first, a resin varnish is prepared by dissolving a thermosetting resin composition constituting the substrate layer in a proper organic solvent (for example, methyl ethyl ketone or toluene). Then, the resin varnish is applied onto a metal foil constituting the metal layer using a bar coater or the like to the desired thickness, and dried to remove the solvent, whereby a packaging material including a metal layer and a substrate layer can be obtained.

In the case of providing an adhesive layer, the adhesive layer can be formed by a method in which a thermoplastic resin or the like that can be bonded by thermocompression is applied using a bar coater or the like or a method in which sheets are pasted together. By controlling the cured state of the thermosetting resin composition, the semi-cured product can also be used as an adhesive layer. The semi-cured product is advantageous in terms of decreased number of processes and reliability since the semi-cured product can be fully cured by heating after bonding and the number of layers can be decreased.

### (Battery)

The packaging material of the present embodiment can be used as a packaging material for various batteries. Examples of the batteries include lithium ion secondary batteries, sodium batteries, solid batteries, and lithium ion polymer batteries. In particular, the packaging material of the present embodiment exhibits flexibility and resistance to deformation loads, and can safely and reliably seal the battery, and is thus suitable as a packaging material for flexible batteries used in smart textiles (e-textiles), card-like devices, game grooves, wristband type devices, glasses type devices, and the like.

### EXAMPLES

First, the components to be used in the preparation of resin compositions in the present Examples will be described.

### (Thermosetting Resin)

Epoxy resin 1 “PMS-14-67” (manufactured by Nagase ChemteX Corporation, epoxy equivalent weight 1800 g/eq)
Epoxy resin 2 “JER (registered trademark) 1003” (manufactured by Mitsubishi Chemical Corporation, epoxy equivalent weight 650 g/eq)
Polyrotaxane “SH2400P” (manufactured by ASM Inc.)

### (Curing Agent)

Monofunctional acid anhydride-based curing agent “YH-307” (manufactured by Mitsubishi Chemical Corporation)
Amine-based curing agent “D2000” (manufactured by MITSUI FINE CHEMICALS, INC.)
Isocyanate resin 1 “D172N” (Mitsui Chemicals, Inc., hexamethylene diisocyanate modified isocyanurate type isocyanate)
Isocyanate resin 2 “D103H” (Mitsui Chemicals, Inc., tolylene diisocyanate modified adduct isocyanate)

### (Others)

Imidazole-based curing accelerator (“2E4MZ” manufactured by SHIKOKU CHEMICALS CORPORATION, 2-ethyl-4-methylimidazole)
Surfactant, fluorine group-containing oligomer “F-556” (manufactured by DIC Corporation)

The respective components were added to a solvent (methyl ethyl ketone) in the mixed amounts (parts by mass) presented in Table 1 below so that the solid concentration was 40 mass % and mixed uniformly (300 rpm, 30 minutes) to prepare resin compositions A to E.

Next, each of the obtained resin compositions was applied onto a 75 μm PET film (support) using a bar coater, dried at 100° C. for 10 minutes to remove the solvent, and then heated and cured at 170° C. for 60 minutes. Each of the obtained cured products was formed into a film having a thickness of 50 μm and a size 6 dumbbell shape (measured part width: 4 mm, parallel part length: 25 mm).

In the elastic modulus test in the present Examples, a tensile test was performed using the sample obtained above at a speed of 25 mm/min using a tensile tester (Autograph (model: AGS-X) manufactured by Shimadzu Corporation) conforming to ISO3384, the slope was calculated from the stress displacement amount and strain amount at two points of 1% strain and 5% strain, and the elastic modulus was calculated.

Table 1 also summarizes the tensile modulus of the cured product of each resin composition.

TABLE 1

| | | Thermosetting | Thermosetting | Thermosetting | Thermosetting | Thermosetting |
|---|---|---|---|---|---|---|
| Composition | | resin A | resin B | resin C | resin D | resin E |
| Thermosetting | Epoxy resin 1 | 94.4 | | | | |
| resin | Epoxy resin 2 | | 41.8 | 28 | 40 | 36.5 |
| | Polyrotaxane | | 45.2 | | 45.2 | |
| | Isocyanate resin 1 | | 14.4 | | | |
| | Isocyanate resin 2 | | | | 14.3 | |
| Curing agent | Acid anhydride-based curing agent | 1.4 | | | | 13 |
| | Amine-based curing agent | | | 21.5 | | |
| Others | Curing accelerator | 0.3 | 0.2 | 0.5 | 0.2 | 0.5 |
| | Surfactant | | 0.5 | | | |

| | | | | | |
|---|---|---|---|---|---|
| Tensile modulus (MPa) | 0.3 | 3.1 | 51 | 101.3 | 381.4 |

### Examples 1 to 3 and Comparative Example 1 and 2

The thermosetting resins A to E obtained above were applied to copper foil (V9S-SV-18, thickness 18 μm, manufactured by FUKUDA METAL FOIL & POWDER CO., LTD.) using a bar coater, the solvent was removed, and then single-sided copper foil films were fabricated so that the thicknesses after curing were 25 μm, 100 μm, and 200 μm, respectively.

### Comparative Examples 3 and 4

As Comparative Example 3, a polyethylene terephthalate (PET) film with copper foil (manufactured by PANAC CO., LTD., configuration: copper foil 18 μm, PET 25 μm, adhesive agent thickness 20 μm) was prepared. As Comparative Example 4, a polyimide (PI) film with copper foil (manufactured by Panasonic Corporation, configuration: copper foil 18 μm, polyimide layer 25 μm) was prepared.

### (Evaluation Test)

As samples for evaluation tests, strip-like patterned test pieces with a width of 10 mm were obtained from the films with copper foil of the respective Examples and Comparative Examples.

Then, an external bending test was conducted as presented below, and evaluation was performed based on the number of cycles until the metal layer (copper foil) broke.
Equipment used: DMLHP-FS (Yuasa system), Resistance meter RM3545-02 (HIOKI)
Test conditions: External bending, bending radius 0.2 mm, test speed: 10 cycles per minute

Test method: The terminals from the resistance meter were attached to both ends of the sample using the equipment under the conditions, each film was evaluated by taking the number of times obtained by subtracting 1 from the number of times at which the resistance value became undetectable as the number of cycles, and the numbers of times were compared.

The results are presented in Table 2.

TABLE 2

| | | Thickness of | Number of | Thickness of | Number of | Thickness of | Number of |
|---|---|---|---|---|---|---|---|
| | Resin film | resin layer | cycles | resin | cycles | resin | cycles |
| Example 1 | Thermosetting resin A | 25 μm | 3824 | 100 μm | 3822 | 200 μm | 3814 |
| Example 2 | Thermosetting resin B | 25 μm | 3822 | 100 μm | 3800 | 200 μm | 3728 |
| Example 3 | Thermosetting resin C | 25 μm | 3798 | 100 μm | 3415 | 200 μm | 2189 |
| Comparative | Thermosetting resin D | 25 μm | 3773 | 100 μm | 3014 | 200 μm | 585 |
| Example 1 | | | | | | | |
| Comparative | Thermosetting resin E | 25 μm | 3633 | 100 μm | 770 | 200 μm | — |
| Example 2 | | | | | | | |
| Comparative | PET | 45 μm | 577 | — | — | — | — |
| Example 3 | | | | | | | |
| Comparative | PI | 25 μm | 317 | — | — | — | — |
| Example 4 | | | | | | | |

### DISCUSSION

In Examples 1 to 3, durability as high as 2000 cycles or more was exhibited in a wide range of thicknesses from 25 μm to 200 μm. On the other hand, in Comparative Example 1 (elastic modulus 101.3 MPa), the durability significantly decreased at a thickness exceeding 100 μm. In Comparative Example 2 (elastic modulus 381.4 MPa), the durability significantly decreased at a thicknesses exceeding 25 μm. In Comparative Examples 3 and 4, poor durability was exhibited even at a thickness of 25 μm. From the above, it was found that the packaging material of the present embodiment exhibits flexibility and high durability against deformation loads.

This application is based on U.S. Provisional Application No. 63/302,886, filed on Jan. 25, 2022, the contents of which are hereby incorporated by reference.

In order to express the present invention, the present invention has been described above appropriately and sufficiently through the embodiments with reference to specific examples, drawings and the like. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

The present disclosure has wide industrial applicability in technical fields related to batteries and packaging materials thereof.

1. A battery packaging material comprising:
a metal layer; and
a substrate layer laminated on at least one surface of the metal layer,
wherein the substrate layer is formed of a thermosetting resin composition of which a cured product has a tensile modulus of 10 kPa or more and 100 MPa or less at 25° C.

2. The battery packaging material according to claim 1, wherein the thermosetting resin composition contains an epoxy resin having an epoxy equivalent weight of 400 g/eq or more.

3. The battery packaging material according to claim 1, further comprising an adhesive layer laminated on a surface of the substrate layer or another surface of the metal layer.

4. The battery packaging material according to claim 1, wherein the substrate layer has a thickness of 8 μm or more and 100 μm or less.

5. The battery packaging material according to claim 1, wherein the metal layer has a thickness of 2 μm or more and 100 μm or less.

6. The battery packaging material according to claim 1, wherein the metal layer is formed of copper foil or aluminum foil.

7. The battery packaging material according to claim 3, wherein the adhesive layer is formed of a resin composition that exhibits adhesive properties at room temperature or by heating, and a cured product of the resin composition has a tensile modulus of 10 kPa or more and 100 MPa or less at 25° C.

8. The battery packaging material according to claim 3, wherein the adhesive layer has a thickness of 1 μm or more and 100 μm or less.
